(19) United States
(12) Patent Application Publication
(10) Pub. No.: US 2010/0039635 A1
(43) Pub. Date: Feb. 18, 2010

(54) Filter Device Disposed in Reticle Library of Lithography System

(76) Inventors: Yu-Chang Liu, Shulin City (TW); Wei-Chien Liu, Shulin City (TW); Yu-Liang Chou, Shulin City (TW)

Correspondence Address: SINORICA, LLC, 2275 Research Blvd., Suite 500, ROCKVILLE, MD, 20850, US

(21) Appl. No.: 12/261,322

(22) Filed: Oct. 30, 2008

(30) Foreign Application Priority Data
Aug. 14, 2008 (TW) 097130940

(51) Int. Cl. G03B 27/62; G03B 27/72

(52) U.S. Cl. 355/71; 355/75

(57) ABSTRACT

A filter device disposed in the reticle library of a lithography system, the lithography system comprising: a light emitting unit for providing a light source, a reticle library disposed with a plurality of reticles, a reticle stage disposed with a fastener for fastening the reticle, a substrate stage disposed with a fastener for fastening the substrate, and a lens module for focusing the light source provided by the light emitting unit and transferring the emitted part of the reticle on the reticle stage to the substrate; the filter device being composed of a bottom base, a top cover, and a chemical absorbent layer, wherein the filter device and the reticle in the lithography system have equal size and are aligned next to each other on support shelves in the reticle library. Thus, the filter device can effectively filter the airborne molecular contaminants (AMC) surrounding the reticle.

### BACKGROUND OF THE INVENTION

1. Field of the Invention

The present invention is related to a filter device, and more particularly, to a filter device disposed in the reticle storage device or the reticle library of lithography system to prevent airborne molecular contaminants (AMC) from forming on the surface of reticle.

2. Description of the Prior Art

In semiconductor process, lithography system plays one of the most important roles. With lithography system, circuit pattern on the reticle can be completely and precisely formed on photoresist on wafer, wherein exposure of the whole wafer is completed by repeatedly shifting the position of wafer for repeatedly performing exposure. In the process of repeatedly performing exposure, after the surface of wafer is under repeated emission of light beam and exposure, some airborne molecular contaminants (AMC) will be generated in the lithography system and will contaminate the reticle. If haze of airborne molecular contamination (AMC) is formed on the reticle, image of this haze will be formed on each exposure area after each exposure, which is called repeated defect and causes serious yield loss of wafer. And the aforementioned haze may form since airborne molecular contaminants (AMC) also follows into the reticle library when the reticle is returned after exposure and thus contaminates neighboring reticles.

According to the conventional art, the solution to this problem of contamination is to inject clean dry air (CDA) or nitrogen into the reticle library for gradually drawing air with airborne molecular contaminants (AMC) out of the equipment through dilution. However, there may still be remnant airborne molecular contaminants (AMC) that have not been fully exhausted or the airborne molecular contaminants (AMC) may still contaminate the reticle during the process of exhaustion and thus causes haze to form on the surface of reticle.

### SUMMARY OF THE INVENTION

In order to avoid defects of the prior art, the present invention provides a filter device disposed in the reticle library of lithography system, wherein a major objective is to provide a filter device to be disposed in the lithography system, the filter device having equal size with the reticle and is aligned next to the reticle on support shelf in the reticle library. Therefore, when the reticle is returned after exposure, airborne molecular contaminants surrounding the reticle can be filtered by the neighboring filter device and directly and effectively removed and thus airborne molecular contamination of other reticles can be avoided.

Another objective of the present invention is to provide a filter device disposed in the lithography system, wherein the filter device has the same thickness as the reticle and thus will not affect the accuracy of machine arm when taking out or placing the reticle. And no modification of the main programs of lithography system is needed for the machine arm to take the proper reticle for performing exposure. Moreover, since this filter device can also have the same weight as the reticle, and thus there will not be problem of overloading for the lithography system.

Still another objective of the present invention is to provide a filter device disposed in object storage device, the object storage device being for storing wafer or reticle or other objects. Since the filter device and the wafer or reticle or other objects are aligned next to each other on the support shelf in the object storage device, the airborne molecular contamination (AMC) or pollution due to other factors of wafer or reticle can be avoided.

According to above objectives, the present invention first provides a filter device composed of a bottom base, a top cover, and a chemical absorbent layer, wherein the bottom base is disposed with a plurality of through holes, the top cover disposed with a plurality of through holes is supported by a stepped platform located along the inner rim of the bottom base, and a chemical absorbent layer is placed in the space formed between the bottom base and the top cover.

Moreover, since the bottom base and the top cover of the filter device can be made of metal, stainless steel or aluminum alloy, enhanced cleanliness can thus be achieved.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a sectional view of a filter device of the present invention;

FIG. 2 is a view of the bottom base and the top cover of a filter device of the present invention;

FIG. 3 is a view of the bottom base and the top cover of another filter device of the present invention;

FIG. 4 is a view of an object storage device or reticle storage device of the present invention;

FIG. 5 is a view of another object storage device or reticle storage device of the present invention; and

FIG. 6 is a view of a lithography system of the present invention.

### DESCRIPTION OF THE PREFERRED EMBODIMENT

In order to disclose the skills applied in, the objectives of, and the effects achieved by the present invention in a more complete and clearer manner, preferred embodiments are herein described in detail below with related drawings disclosed for reference.

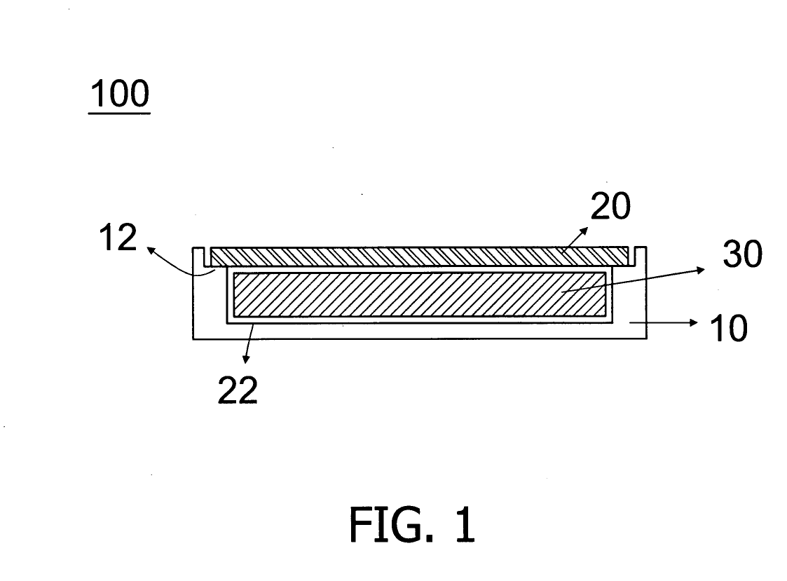

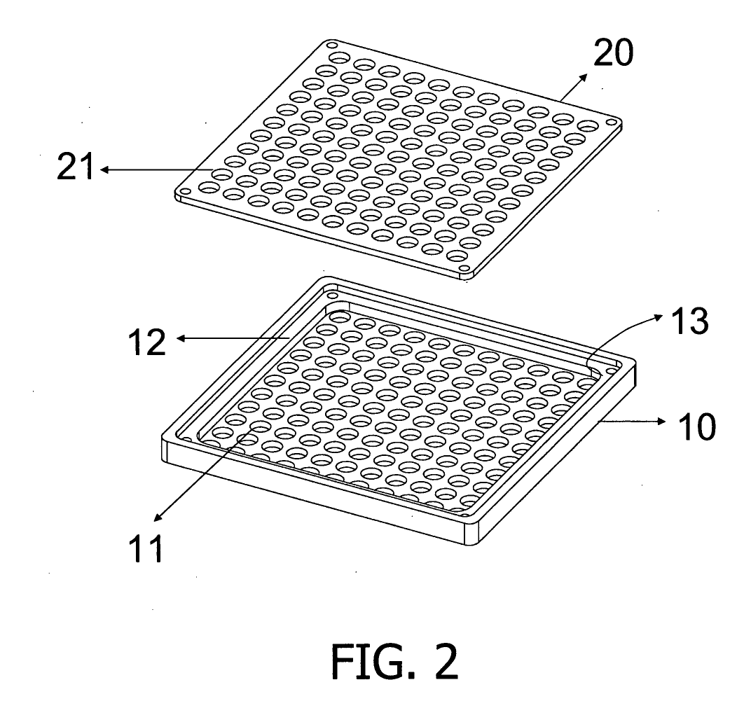

First, referring to FIG. 1, which is a sectional view of a filter device of the present invention. The filter device 100 includes a bottom base 10, a top cover 20, and a chemical absorbent layer 30. Wherein, as shown in FIG. 2, the bottom base 10 is disposed with a plurality of through holes 11 and a stepped platform 12 is located along the inner rim of the bottom base 10 for supporting a top cover 20 disposed with a plurality of through holes 21 to form an interior space 22 after the bottom base 10 and the top cover 20 are joined together, a chemical absorbent layer 30 being placed in the interior space 22.

The bottom base 10 and the top cover 20 as described above can be made of metal material, such as stainless steel or aluminum alloy; using stainless steel or aluminum alloy not only facilitates the cleaning process but also makes it less easier for airborne molecular contaminants (AMC) to adhere, and thus more enhanced cleanliness can be achieved. The plurality of through holes 11 and 21 on the bottom base 10 and the top cover 20 are coupled to each other, the design of which facilitates air circulation for leading airborne molecular contaminants (AMC) to be absorbed by the chemical absorbent layer 30 through the plurality of through holes 11 and 21. And the chemical absorbent layer 30 can be formed by chemical absorbents, and more particularly, an activated carbon.

Moreover, near the four corners of stepped platform 12 located along the inner rim of bottom base 10, the stepped platform 12 can further extend inward for form four fastening platforms 13. The plurality of fastening platforms 13 allow a plurality of fastening elements (not shown in Figure) to fasten the top cover 20 to the bottom base 10 to enhance its stability. And the fastening element can be screw or quick release fastener for the top cover 20 and the bottom base 10 to be quickly separated and for the replacement of chemical absorbent layer 30 to be completed more easily.

And the aforementioned filter device 100 can be a rectangular solid structure in form, with preferred width of two sides as 71˜152.4 mm and preferred thickness as 3.35˜11.85 mm. Moreover, in a preferred embodiment, the weight of filter device 100 can be in the range of 150˜600 grams depending on the material used. However, what is to be emphasized is that, the form and size of filter device 100 as described above is only a preferred embodiment of the present invention and not for limiting the scope of the present invention.

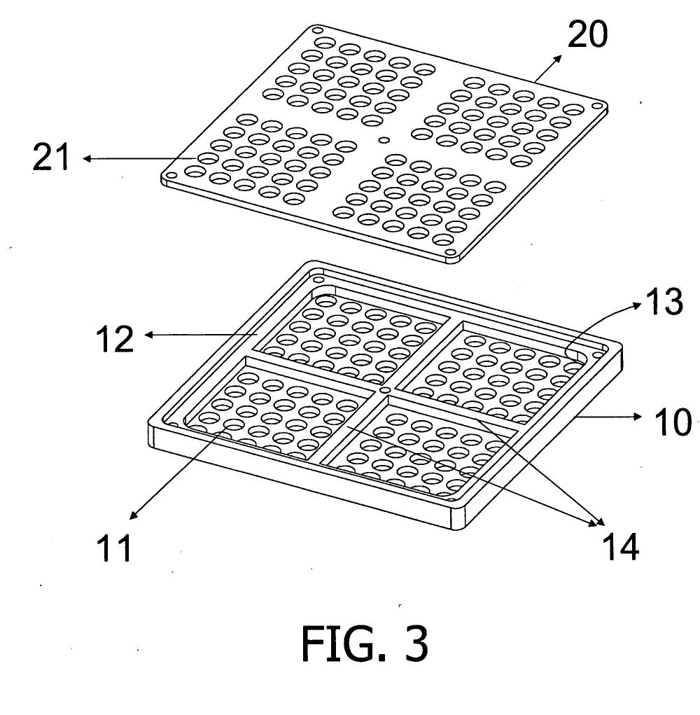

Then, referring to FIG. 3, which is a view of bottom base and top cover of another filter device of the present invention. Similar to the embodiment as described above, the bottom base 10 and the top cover 20 are also made of metal material and a chemical absorbent layer 30 is placed in the interior space 22 formed after the bottom base 10 and the top cover 20 are joined together. The difference is that two supporting ribs 14 extending inward and perpendicular to each other are disposed in the middle section of inner side of the bottom base 10 for separating the bottom base 10 into a plurality of areas, each area including a plurality of through holes 11. And the plurality of through holes 21 of the top cover 20 disposed on top of the bottom base 10 can be correspondingly disposed at the plurality of areas to be coupled with the plurality of through holes 11 of the bottom base. The above-mentioned supporting ribs 14 are used for supporting the top cover 20 to enhance the overall stability of the filter device. Moreover, at least a fastening element (not shown in Figure) is allowed to be disposed at the place where supporting ribs 14 cross each other for the top cover 20 to be more firmly fastened to the bottom base 10.

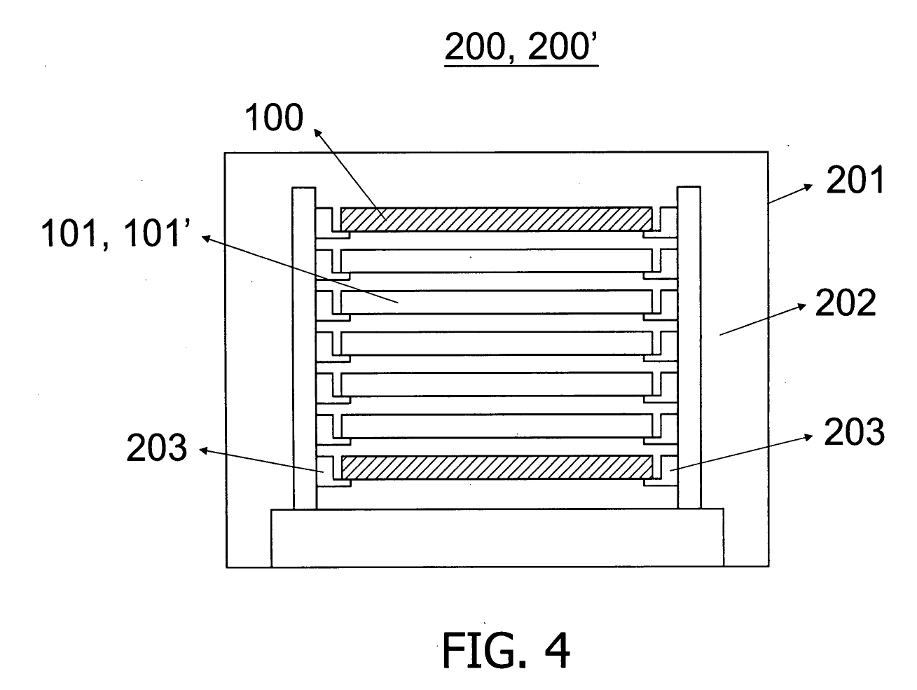

Then, referring to FIG. 4, which is a view of an object storage device of the present invention. The object storage device 200 includes a case body 201, in which is a space for accommodation 202 and on one side of which is formed with an opening (not shown in Figure). The space for accommodation 202 is disposed with a plurality of supports 203 for separating the space for accommodation 202 into a plurality of storage spaces with same size, and thus at least a filter device 100 and at least an object 101 can be disposed in the storage space. As described above, each filter device 100 and each object 101 have the same size. Moreover, the weight of filter device 100 can also be the same as that of object 101 in order not to affect the loading of the whole object storage device 200. What is to be emphasized here is that, the object 101 in the present embodiment can be a reticle, and can also be a wafer, which is not limited in the present invention.

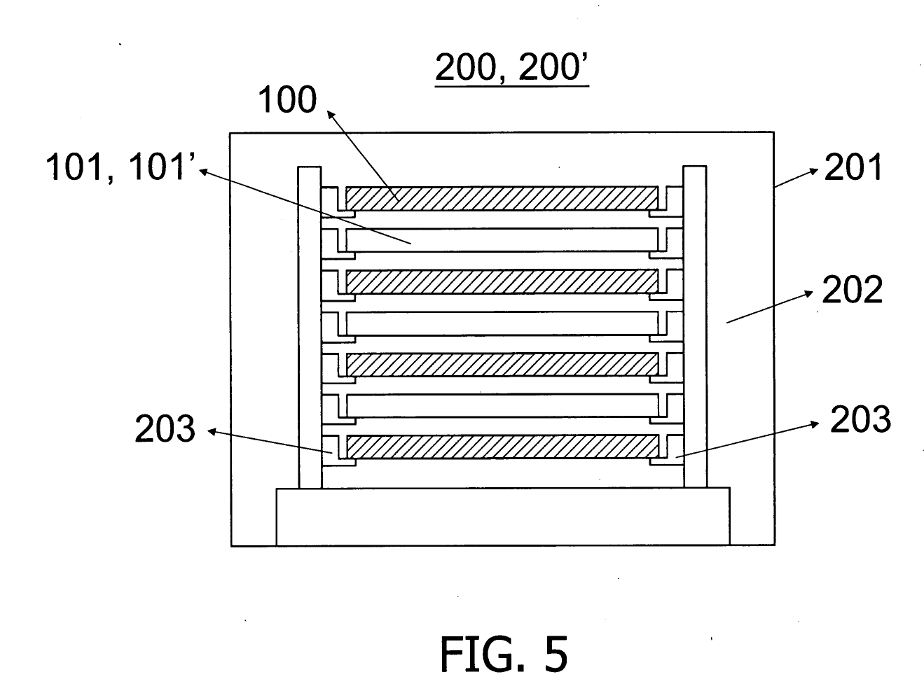

The aforementioned plurality of objects 101 are stored in the plurality of storage spaces with same size partitioned in the space for accommodation 202 of the object storage device 200, and the filter device 100 can also be stored in the plurality of storage spaces since its size is the same as the object 101. Wherein, in the plurality of storage spaces with same size, the filter device 100 can be stored in the uppermost layer or the lowermost layer of the plurality of storage spaces with same size for first absorbing airborne molecular contaminants (AMC) in the space for accommodation 202 of the object storage device 200 and prevent the airborne molecular contaminants (AMC) from contaminating the object 101. Of course, as also shown in FIG. 4, the filter device 100 can be stored in the uppermost layer or the lowermost layer of the plurality of storage spaces with same size to achieve the best effect of filtering. Moreover, in another preferred embodiment as shown in FIG. 5, the filter device 100 and the object 101 are disposed at intervals in the plurality of storage spaces with same size for the filter device 100 to filter all airborne molecular contaminants around each object 101 and to prevent the airborne molecular contaminants from contaminating the object 101. And as also described above, the case body 201 of the object storage device 200 includes an opening for importing or exporting the object 101 and the filter device 100.

Of course, as shown in FIG. 4 and FIG. 5, the object storage device 200 of the present invention can also be a reticle storage device 200′ for storing a plurality of reticles 101′. What is to be emphasized in particular is that, the size of filter device 100 and the size of reticle 101′ are the same, so the filter device 100 can be stored in the plurality of storage spaces with same size of the reticle storage device 200′. And the alignment of the filter device 100 and the reticle 101′ in the reticle storage device 200′ is similar to the alignment in the object storage device 200 as described above; therefore, the filter device 100 can effectively filter the airborne molecular contaminants (AMC) around the reticle 101′ to prevent the airborne molecular contaminants (AMC) from contaminating the reticle 101′.

The size of the filter device 100 is the same as that of the reticle 101′ and thus the filter device 100 can be placed at any storage place in the reticle storage device 200′, the merit of the design of which is that the filter device 100 can be adjusted to be placed at any storage place depending on the location of airborne molecular contaminants (AMC) to be removed. Moreover, the weight of filter device 100 can also be the same as that of the reticle 101′ and thus there will not be problem of overloading for the reticle storage device 200′.

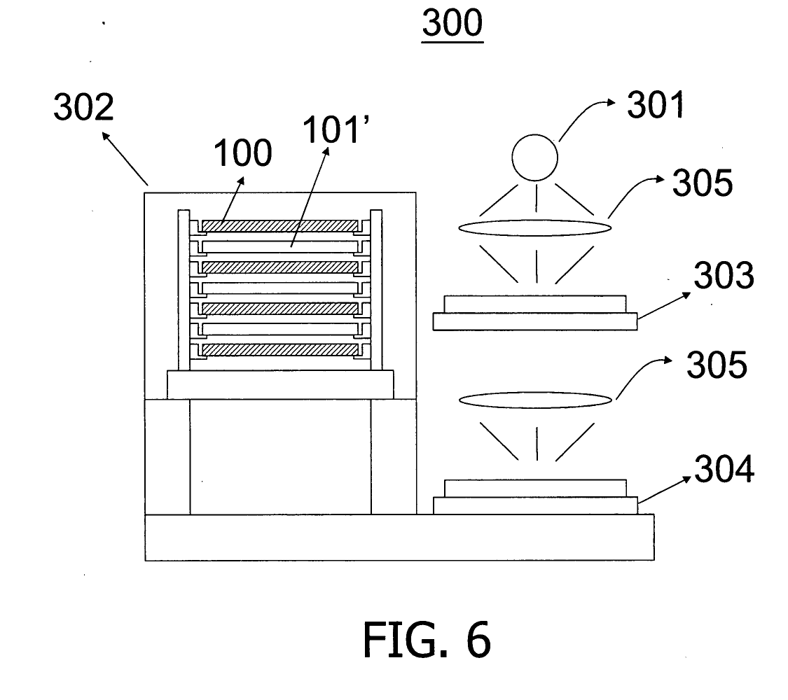

Then, referring to FIG. 6, which is a view of lithography system of the present invention. The lithography system 300 comprises a light emitting unit 301 for providing a light source, a reticle library 302 disposed with a plurality of reticles 101′, a reticle stage 300 disposed with first fastener for fastening reticle taken out from the reticle library 302, a substrate stage 304 disposed with second fastener for fastening a substrate, obviously the substrate being able to be a wafer or other materials that need to be exposed, such as a glass substrate, and a lens module 305 for focusing the light source provided by the light emitting unit 301 and transferring the emitted part of reticle on the reticle stage 303 to the target area of the substrate. And the aforementioned reticle library 302 includes a case body, which includes a space for accommodation and on one side of which is formed with an opening (not shown in Figure), this opening being provided for importing or exporting reticles 101′ or filter device 100. And the space for accommodation is disposed with a plurality of supports for separating the space for accommodation into a plurality of storage spaces with same size to be disposed with at least a filter device 100 and a plurality of reticles 101′. What is to be emphasized in particular is that each filter device 100 as described above has the same size as each reticle 101′. And the filter device 100, as already described above, is composed of a bottom base 10, a top cover 20, and a chemical absorbent layer 30. The top cover 20 can be further fastened to the bottom base 10 by a fastening element to form an interior space 22, and the chemical absorbent layer 30 is placed in this interior space 22. This chemical absorbent layer 30 can be formed by chemical absorbents, and more particularly, an activated carbon. And the bottom base 10 and the top cover 20 are made of metal material, with stainless steel or aluminum alloy being preferred materials, in order to enhance the cleanliness of filter device 100. Obviously, since the filter device 100 and the reticles 101′ have the same size, therefore no mistake in taking or placing reticle will occur due to different size of filter device 100 when the reticle is to be taken or placed by the lithography system 300. Moreover, the weight of filter device 100 can also be the same as that of reticle 101′ in order not to affect the loading of the whole lithography system 300 and cause overloading.

The alignment of filter device 100 and reticles 101′ in the reticle library 302 of lithography system 300 is similar to that in the reticle storage device 200′. The filter device 100 can be stored at any position in the plurality of storage spaces with same size, and can certainly be stored at the uppermost layer or the lowermost layer. And in a preferred embodiment, the filter device 100 and the reticles 101′ are disposed at intervals in the plurality of storage spaces with same size for more effectively prevent airborne molecular contaminants (AMC) from contaminating reticles 101′ and reticles within.

While the invention has been described by way of examples and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A filter device, including: a bottom base, being disposed with a plurality of through holes and a stepped platform being formed along the inner rim of said bottom base to support a top cover disposed with a plurality of through holes for forming an interior space after said bottom base and said top cover being joined with each other, the characteristic in that:
said bottom base and said top cover are formed by metal and a chemical absorbent layer is placed in said interior space formed after said bottom base and said top cover are joined with each other.

2. The filter device according to claim 1, wherein said chemical absorbent layer is selected from the group consisting of:
chemical absorbents and activated carbon.

3. The filter device according to claim 1, wherein material of said bottom base and said top cover is selected from the group consisting of: stainless steel and aluminum alloy.

4. The filter device according to claim 1, wherein said pluralities of through holes of said bottom base and of said top cover are coupled to each other.

5. The filter device according to claim 1, wherein said bottom base and said top cover being joined with each other with a fastening element.

6. The filter device according to claim 1, said filter device being a rectangular structure.

7. An object storage device disposed with filter device, including a case body, said case body including a space for accommodation and an opening being formed on one side of said case body, a plurality of supports being disposed in said space for accommodation for separating said space for accommodation into a plurality of storage spaces with same size to be placed with at least a filter device and at least an object, the characteristic in that:
each of said filter device has same size as each of said object.

8. The object storage device according to claim 7, wherein said object is a reticle.

9. The object storage device according to claim 7, wherein said filter device includes: a bottom base, being disposed with a plurality of through holes and a stepped platform being formed along the inner rim of said bottom base to support a top cover disposed with a plurality of through holes for forming an interior space after said bottom base and said top cover being joined with each other, a chemical absorbent layer being further disposed in said interior space.

10. The object storage device according to claim 9, wherein said pluralities of through holes of said bottom base and of said top cover are coupled to each other.

11. The object storage device according to claim 9, wherein said chemical absorbent layer is selected from the group consisting of:
chemical absorbents and activated carbon.

12. The object storage device according to claim 9, wherein material of said bottom base and said top cover is selected from the group consisting of: stainless steel and aluminum alloy.

13. The lithography system disposed with filter device, comprising a light emitting unit for providing a light source, a reticle library disposed with a plurality of reticles, a reticle stage disposed with a first fastener for fastening a reticle, a substrate stage disposed with a second fastener for fastening a substrate, a lens module for focusing light source provided by said light emitting unit and transferring an emitted part of said reticle on said reticle stage to a target area of said substrate, the characteristic in that:
said reticle library is disposed with at least a filter deice and said filter device has the same size as said reticle.

14. The lithography system according to claim 13, wherein said filter device includes: a bottom base, being disposed with a plurality of through holes and a stepped platform being formed along the inner rim of said bottom base to support a top cover disposed with a plurality of through holes for forming an interior space after said bottom base and said top cover being joined with each other, a chemical absorbent layer being further disposed in said interior space.

15. The lithography system according to claim 14, wherein said chemical absorbent layer is selected from the group consisting of:
chemical absorbents and activated carbon.

16. The lithography system according to claim 14, wherein material of said bottom base and said top cover is selected from the group consisting of: stainless steel and aluminum alloy.

17. The lithography system according to claim 14, wherein said pluralities of through holes of said bottom base and of said top cover are coupled to each other.

18. The lithography system according to claim 13, wherein said reticle library includes a case body, said case body including a space for accommodation and an opening being formed on one side of said case body, a plurality of supports being disposed in said space for accommodation for separating said space for accommodation into a plurality of storage spaces with same size to be placed with at least a filter device and at least a reticle.

19. The lithography system according to claim 18, wherein said filter device is placed at any position in said plurality of storage spaces with same size.

20. The lithography system according to claim 18, wherein said filter device and said reticle are disposed at intervals in said plurality of storage spaces with same size.
